(19) United States
(12) Patent Application Publication
(10) Pub. No.: US 2003/0063827 A1
(43) Pub. Date: Apr. 3, 2003

(54) Compact hub assembly for automotive vehicles

(75) Inventors: Alan C. Webb, Northhampton (GB); Timothy J. Krabill, Louisville, OH (US); Steven A. Roman, Canton, OH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timken Company

(21) Appl. No.: 09/969,490

(22) Filed: Oct. 2, 2001

(51) Int. Cl. F16C 13/00

(52) U.S. Cl. 384/544

(57) ABSTRACT

A hub assembly for coupling the road wheel of a vehicle to the suspension system of the vehicle includes a hub provided with a spindle, a housing surrounding the spindle of the hub, and an antifriction bearing located between the spindle and the housing. The bearing includes tapered rollers arranged in two rows as well as a pair tapered inner raceways carried by the spindle and a pair of tapered outer raceways carried by the housing. One of the tapered inner raceways is on a race that is initially separate from the housing, and this race has a recess that opens axially out of its end. The spindle has an integrally formed end that is received in the recess. The spindle and inner race may be engaged with splines and the inner race may further have an axial extension provided with an external spline that is selectively engaged by a connect-disconnect ring on a CV joint.

### BACKGROUND OF THE INVENTION

This invention relates in general to automotive hub assemblies and, more particularly, to a highly compact hub assembly.

Automotive manufacturers over the years have sought to reduce the number of procedures required to assemble their automobiles or other automotive vehicles. One area where this effort has proved to be particularly effective is in the mounting of the road wheels. Instead of installing wheel hubs and bearings separately along the assembly lines, for many automobiles they are now installed as packaged units. Each unit includes a housing that bolts to the suspension system of the vehicle, a hub that rotates in the housing, and a bearing located between the hub and the housing to facilitate the rotation. The typical hub has a flange to which the road wheel is secured with lug bolts and a spindle that extends through the bearing in the housing. In some hub assemblies of current manufacture, the inboard end of the spindle is deformed outwardly behind the inboard bearing to permanently unite the hub, housing, and bearing. The end that is so formed increases the length of the hub assembly, and occupies space in an area where space is at a premium. The increase in length moreover, often contributes to a greater than desired scrub radius, which is the distance along the road surface between the center plane of the wheel and the steering axis. The scrub radius affects turning and other handling characteristics and should be as close to zero as possible. Also, where the package bearing mounts a driven wheel, the formed end presents a relatively soft steel surface opposite a hardened steel surface on a CV (constant velocity) joint, and as a consequence the formed end suffers as the CV joint pounds against or otherwise undergoes movement relative to it as will occur when the CV joint transmits torque to the hub.

### SUMMARY OF THE INVENTION

The present invention resides in a hub assembly for coupling the road wheel of an automotive vehicle to the suspension system of the vehicle. The hub assembly includes a hub provided with a spindle, a housing surrounding the spindle of the hub, and a bearing located between the spindle and the housing. The bearing has inner and outer raceways and rolling elements located in two rows between the raceways. One of the inner raceways is on an inner race that is initially separate from the spindle, and that race is retained on the spindle by a formed end at the end of the spindle. The inner race has a recess that opens out of it and receives the formed end, thus reducing the length of the bearing assembly. The invention also resides in a process for deforming the end of an initially straight spindle into a recess in the end of a bearing race.

### DESCRIPTION OF THE DRAWINGS

FIG. 1 is a sectional view of a hub assembly according to an embodiment of the present invention;

FIG. 2 is an end view of the hub assembly taken along line 2-2 of FIG. 1;

FIG. 3 is a sectional view of the hub assembly coupled to a CV joint for transmitting torque to the hub of the bearing assembly according to an embodiment of the present invention;

FIG. 4 is a sectional view of a modified hub assembly, the hub of which is selectively coupled to a CV joint through a connect-disconnect ring on the CV joint according to an embodiment of the present invention;

FIG. 5 is a sectional view of another modified hub assembly according to an embodiment of the present invention;

FIG. 6 is a sectional view of a hub perform according to an embodiment of the present invention; and

FIGS. 7A-7C are sectional views of a forming tool deforming a hub perform in order to attach a hub to a housing according to an embodiment of the present invention.

### DETAILED DESCRIPTION OF PREFERRED EMBODIMENTS

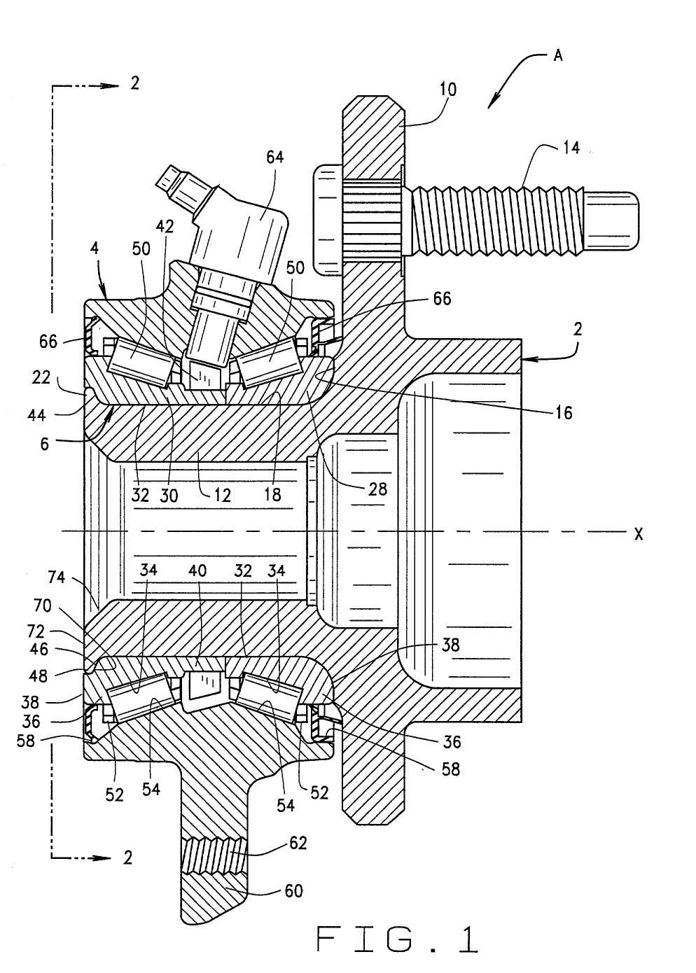

Referring now to the drawings, a hub assembly A (FIG. 1), which mounts a road wheel (not shown) for an automotive vehicle on the suspension system of the vehicle, includes a hub 2, a housing 4 that is generally located around the hub 2, and a bearing 6 which enables the hub 2 to rotate relative to the housing 4 about an axis X of rotation with minimal friction. A road wheel and a brake rotor (not shown) are attached to the hub 2, while the housing 4 is secured firmly against a component of the vehicle suspension system, such as a steering knuckle (not shown).

The hub 2 has (FIG. 1) a flange 10 and a spindle 12 which are joined together as an integral steel forging or casting, with the spindle 12 projecting from one face of the flange 10. Radially beyond the spindle 12 the flange 10 contains wheel studs 14 that project axially from its other face. Lug nuts (not shown) thread over the wheel studs 14 to fasten a brake rotor and road wheel to the hub 2. The spindle 12, which is shown as hollow but may also be formed of a solid construction, emerges from a shoulder 16 located along the inside face of the flange 10, and the outwardly presented surface of the spindle 12 forms a bearing seat 18 around which the bearing 6 is located. Beyond the bearing seat 18 the spindle 12 has a formed end 22 that is directed outwardly as an integral part of the spindle 12.

The bearing 6 includes (FIG. 1) two inner races in the form of an outboard cone 28 and an inboard cone 30, each having a bore 32, which extends completely through it. The bores 32 of the two cones 28 and 30 receive the spindle 12 of the hub 2, there being an interference fit between the bearing seat 18 and cone bores 32. Thus, the two cones 28 and 30 are captured on the spindle 12 between the shoulder 16 and the formed end 22. Each cone 28 and 30 is formed from case-hardened or through-hardened steel and has a tapered raceway 34 that is presented outwardly away from the axis X, a thrust rib 36 at the large end of its raceway 34, and a back face 38 which is on the end of the thrust rib 36 where it is squared off with respect to the axis X. While the outboard cone 28 and the inboard cone 30 are shown as separate pieces attached to the spindle 12, one or both cones 28, 30 may be formed integrally with the spindle.

The inboard cone 30 is somewhat longer than the outboard cone 28 by reason of a cone extension 40 which projects beyond the small end of its raceway 34 and serves as a seat for a target wheel 42 used in monitoring the rotation of the hub 2. However, one of ordinary skill in bearing design would recognize the outboard cones 28, 30 could also be used as a seat for target wheel 42. At its opposite end, the inboard cone 30 has (FIG. 1) a recess 44 that opens out of its back face 38, it being defined by a beveled surface 46 and a short axial surface 48. The beveled surface 46 leads from the cone bore 32 to the axial surface 48 and lies within a conical envelope that is oblique to the axis X and the plane of the back face 38, it being closer to that plane at its outer margin than at its inner margin. Indeed, the beveled surface 46 at its outer margin intersects the axial surface 48 and the axial surface 48 leads out to the back face 38. The included angle between the envelope of the beveled surface 46 and the axis X may range between 20° and 90° and preferably is about 70°, although any particular angle would be within the scope of the present invention.

The inboard cone 30 at its small cone extension 40 abuts the small end of the outboard cone 28 along the bearing seat 18; that is to say, the two cones 28 and 30 abut at their front faces. The back face 36 of the outboard cone 28 abuts the shoulder 16 at the flange 10, while the formed end 22 occupies the recess 44 of the inboard cone 30 and here bears against the beveled surface 46. Thus, the two cones 28 and 30 are captured between the shoulder 16 and the formed end 22.

In addition to the cones 28 and 30, the bearing 6 includes (FIG. 1) tapered rollers 50 arranged in two rows, there being a separate row around each cone 28 and 30. Actually, the rollers 50 extend around the raceways 34 for the cones 28 and 30, with their tapered side faces being along the raceways 34 and their large end faces against the thrust ribs 36. The rollers 50 of each row are essentially on apex, which means that the envelopes in which their tapered side faces lie have their apices located at a common point along the axis X. Each row of rollers 50 has a cage 52 to maintain the proper spacing between the rollers 50 in that row.

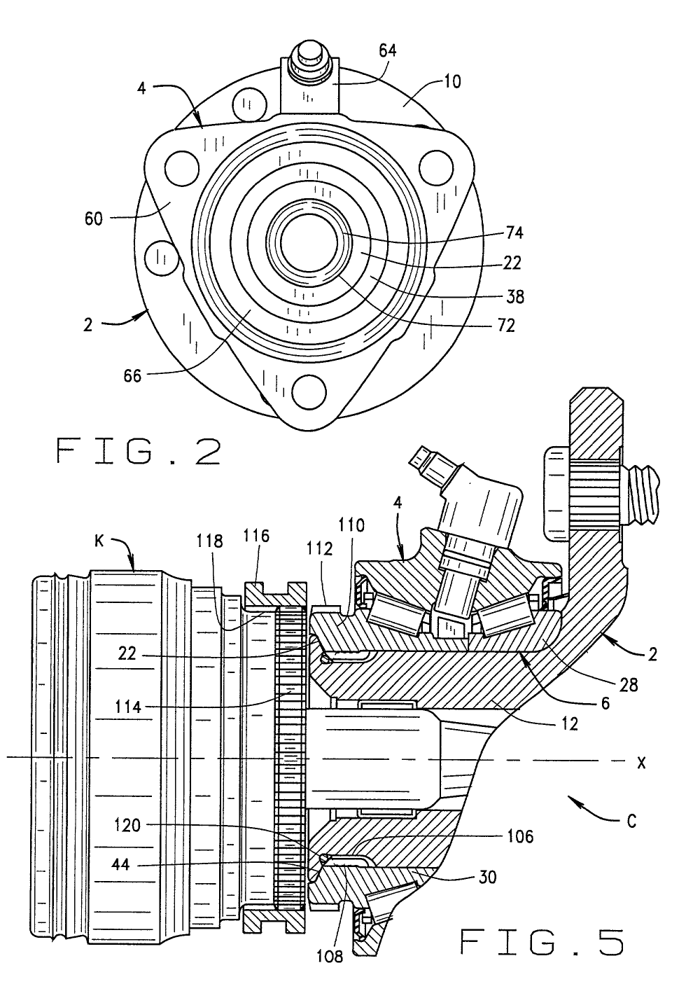

The housing 4 surrounds the spindle 12 as well as the two cones 28 and 30 and the two rows of rollers 50 (FIG. 2). It forms part of the bearing 6 in that it has tapered raceways 54 which are presented inwardly toward the axis X. In that sense, the housing 4 constitutes the outer race of the bearing 6. The raceways 54 on the housing 4 taper downwardly toward an intervening surface that separates them. The rollers 50 likewise lie along the raceways 54 of the housing 4, contacting the raceways 54 along their tapered side faces. At their large ends, the raceways 54 open into short counterbores 58 in which the thrust ribs 34 of the two cones 28 and 30 are located.

Generally midway between its ends, the housing 4 has a triangular or rectangular flange 60 (FIG. 2) (although other shapes are possible) that fits against a component of a suspension system for a vehicle. Here the housing A is secured firmly to the suspension system component with bolts that engage threaded holes 62 located in the lobes of the flange 60 or at least they pass through the lobes in the flange 60. The housing A also carries a speed sensor 64 which projects into the space between the two rows of rollers 50 where it monitors the rotation of the target wheel 42.

The counterbores 58 in the housing 4 contain seals 66 which fit around the thrust ribs 36 on the cones 28 and 30 to establish dynamic fluid barriers at the ends of the housing 4. These barriers isolate the rollers 50 and the raceways 32 and 54 from road contaminants, such as water, ice-melting salts, and dirt.

The formed end 22 occupies the recess 44 at the end of the inboard cone 30, but does not project beyond the back face 38 of the inboard cone 30. It turns outwardly from the bearing seat 18 and bears against the beveled surface 46 at the back of the recess 44. Indeed, the formed end 22 has a beveled inside surface 70 which contacts the beveled surface 46 of the recess 44 from the bearing seat 18 outwardly to the axial surface 48 of the recess 44. In the most preferred form, no gap exists between the formed end 22 and the surfaces 46 and 48 of the recess 44 in the cone 30. Furthermore, the formed end 22, optimally, does not possess any folds or wrinkles where it turns outwardly away from the bearing seat 18, even though its presence derives from a plastic deformation of the spindle 12. The formed end 22 also has planar end face 72 that lies within the plane of the back face 38 for the cone 30, although it may be set slightly inwardly from that face as well. Finally, it has a transition surface 74 between the planar end face 72 and the hollow interior of the spindle 12.

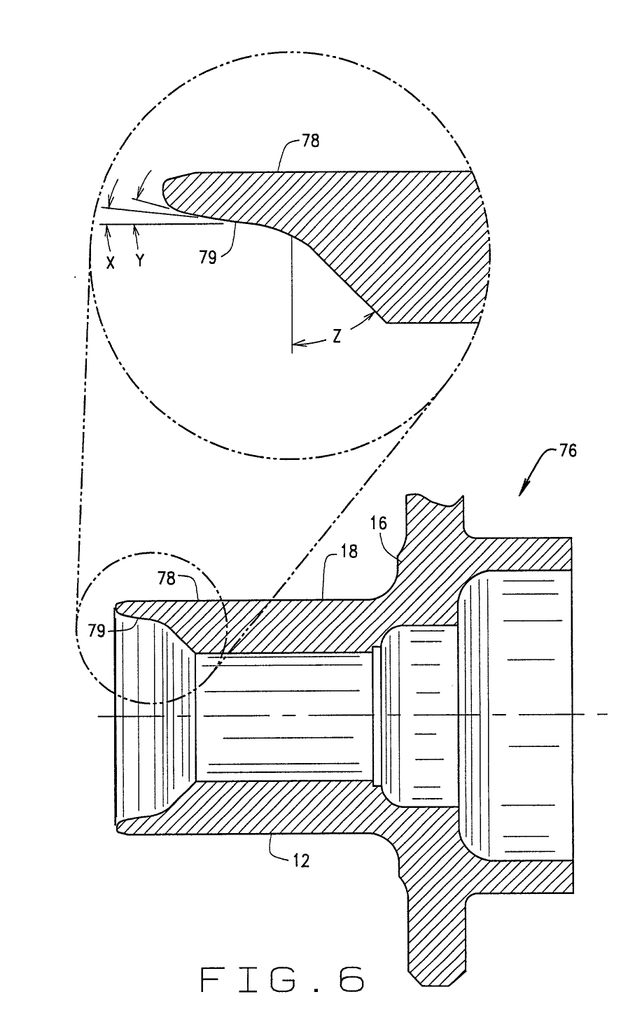

The hub 2 does not initially have the formed end 22. At the outset the hub 2 exists as a preform 76 (FIG. 6), which is shown in the condition in which it is forged or cast and then machined. In the preform 76 the spindle 12 extends from the shoulder 16 through its cylindrical bearing seat 18, and beyond the bearing seat 18 as an axially directed end portion 78 having a cylindrical outside surface, the diameter of which is no greater than the diameter of the seat 18. An interior surface 79 of the end portion 78 preferably comprises three angles X, Y and Z, although it is within the scope of the present invention to provide more or fewer tapers. The angles X, Y, Z aid in the forming of the end portion 78 by reducing the thickness of the end portion 78 from the thickness of the bearing seat 18. Most preferably, the angle X is 4 degrees, the angle Y is 13 degrees and the angle Z is 45 degrees.

To assemble the hub assembly A, the rollers 50 and cages 52 are placed between the tapered raceways 54 of the housing 4 and the tapered raceways 34 of the cones 28, 32 to form a bearing subassembly. This subassembly is then pressed over the bearing seat 18 of the spindle 12 until the back face 38 of the cone 28 bears against the shoulder 16 on the flange 10. The hub 2 is then rotated relative to the housing 4 to insure that the rollers 50 of the two rows seat properly against the raceways 34 and 54.

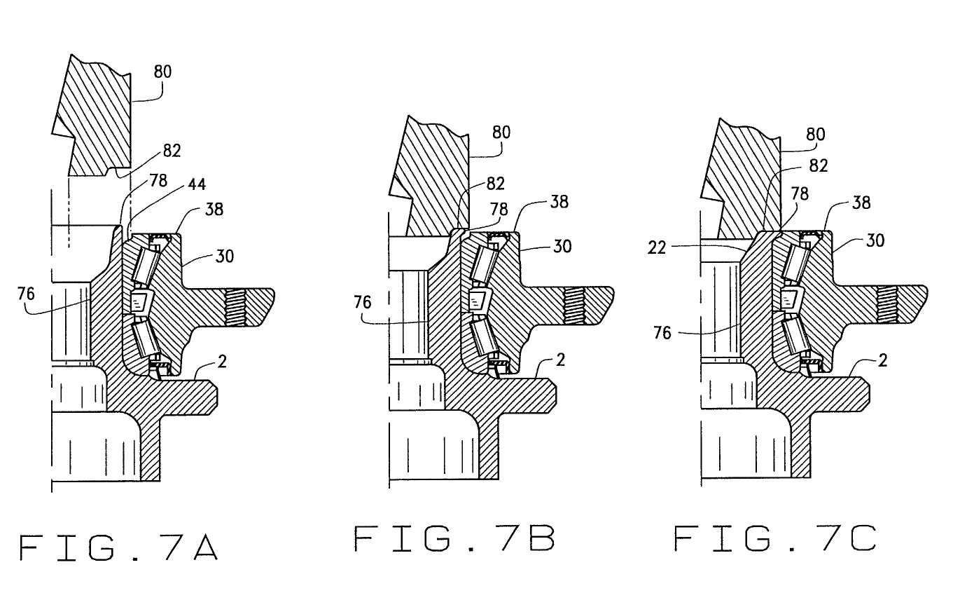

Referring to FIGS. 7A, 7B and 7C, with the hub 2 rotating and the end portion 78 of the preform 76 exposed beyond the back face 38 of the inboard cone 30, a forming tool 80 is brought against the end portion 78 of the preform 76, while the hub 2 rotates. The tool 80 has a shaping face 82 which will impart the desired configuration to the end face 72 and transition surface 74 on the formed end 22. The tool 80 is driven against the rotating end portion 78 with enough force to plastically deform the end portion 78 outwardly and then into the recess 44, thus producing the formed end 22. Indeed, the recess forms a die cavity so to speak, which determines the shape of the formed end 22. The transformation involves more than a simple bending or flaring of the end portion 78, but instead a total deformation and redistribution of the metal of the end portion to create a cross section of totally different configuration.

International application PCT/GB 98/01823, filed Jun. 22, 1998 and published 30 Dec. 30, 1998 under International Publication No. WO 98/58762, discloses a rotary forming process for upsetting the end portion of a preform and converting it into the formed end that captures two cones on a spindle 12 to unitize a bearing. However, the shaping face of the tool takes on a somewhat different configuration, so that it does not interfere with the back face 34 of the cone 30.

When the hub assembly A is in use, its hub 2 rotates within the housing 4 as the road wheel, which is bolted to the flange 10 of the hub 2, rolls over a road or other surface. The bearing 6 reduces friction between the spindle 12 of the hub 2 and the housing 4 and further transfers radial and thrust loads between hub 2 and the housing 4, the latter of which is attached to the suspension system of the vehicle.

The hub assembly A may couple a non-driven wheel to the suspension system of a vehicle, and the suspension system component to which the assembly is attached may pivot to steer the vehicle or it may not as typically holds true with regard to the rear wheels on vehicles.

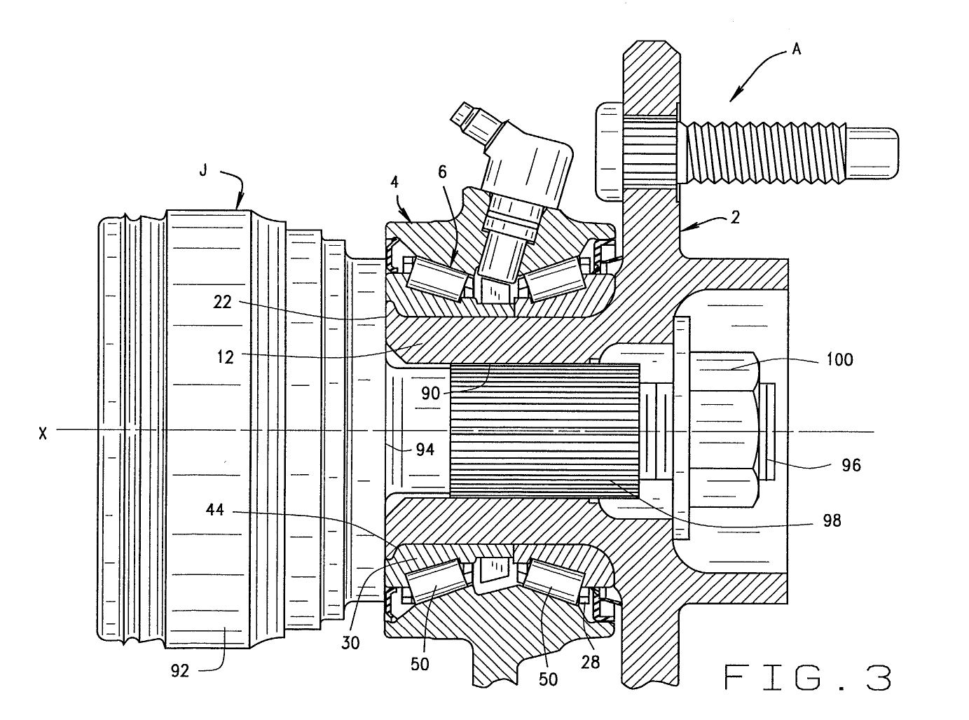

With a slight modification, the hub 2 of the hub assembly A can be coupled to a CV joint J at the end of a drive shaft to transfer torque from the drive shaft to the hub 2 and thence to the wheel to propel the vehicle. That modification resides in (FIG. 3) an internal spline 90 formed along surface of the hollow interior of the spindle 12. The CV joint J has a shell 92 and a front face 94 at the outwardly presented end of the shell 92. In addition, it has a stub shaft 96 which projects from the shell 92 away from its front face 94. The stub shaft 96 extends into the hollow interior of the spindle 12 for the hub 2 and has an external spline 98 that engages the internal spline 90 in the spindle 12. The front face 94 on the shell 92 bears against the back face 38 of the inboard cone 30 for the bearing 6, it being drawn snugly against the back face 38 by a nut 100 which threads over the end of the stub shaft 96.

As the CV joint J and hub 2 of the hub assembly A rotate, minute movements and flexures may occur between the front face 96 of the CV joint J and the back face 38 of the inboard cone 30 for the bearing 6. Both of these faces exist on hardened steel—either through-hardened or case-hardened—and as a consequence minimal wear occurs. Certainly less wear occurs than the situation where the hardened front face 94 of the CV joint J contacts the softer steel of the formed end 22 on the spindle 12.

A modified hub assembly B (FIG. 4), while resembling the hub assembly A, selectively connects and disconnects with a CV joint K that is in many respects similar to the CV joint J. This enables the hub 2 to rotate freely or when necessary be coupled to the CV joint K so that torque is transmitted to the hub 2 and the wheel that is on it.

To this end, the spindle 12 of the hub 2 has an external spline 106 which is offset axially a slight distance from the formed end 22 or more accurately from end portion 78 on the preform 76 before the deformation of that end portion 78 into the formed end 22. As a consequence, the spline 106 does not produce stress concentrations in the formed end 22. The major diameter of the spline 106 does not exceed the diameter of the bearing seat 18 so the spline 106 will not interfere with the installation of the cones 28 and 30 on the spindle 12.

The inboard cone 30, on the other hand, has an internal spline 108 that projects inwardly from the surface of the cone bore 32 and engages the external spline 106 on the spindle 12. The spline 108 likewise terminates short of the formed end 22 and thus does not impart stress concentrations to it. Finally the inboard cone 30 beyond its thrust rib 36 has a large extension 110 that is provided with an external spline 112. The back face 38 and recess 44 are on the extension 110.

The CV joint K, like the joint J, has a shell 92 provided with a front face 94 and also a stub shaft 96 which projects beyond the front face 94 into the hollow interior of the spline 12. Here the stub shaft 96 is fitted to the spindle 12 with antifriction bearings 113 which enable the housing 4 to rotate relative to the spindle 12 and of course allow the CV joint K to rotate relative to the hub 2 about the axis X. Moreover, the shell 92 of the CV joint K has an external spline 114 located immediately behind its front face 94, and the spline 114 aligns with and matches the configuration of the external spline 112 on the large extension 110 of the inboard cone 30. The shell 92 carries a connect-disconnect ring 116 having an internal spline 118 that engages the external spline 112 loosely enough to enable the ring 116 to slide axially on the external spline 112. Indeed, the connect-disconnect ring 16 is long enough to span the space between the matching external splines 112 and 114, while not only remaining engaged with the spline 112, but also engaging the spline 114.

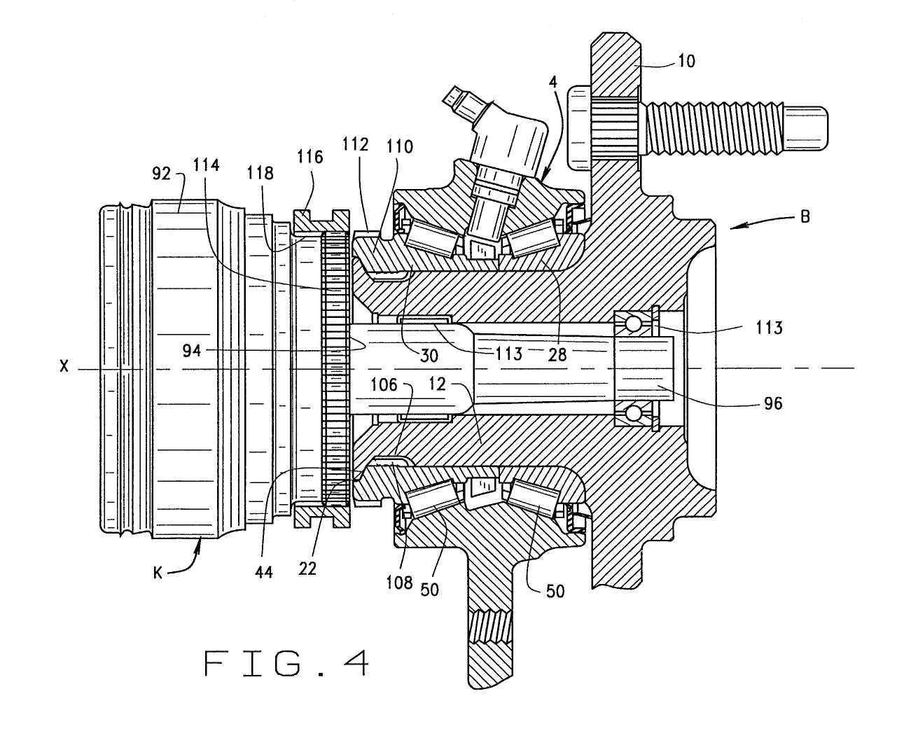

Another modified hub assembly C (FIG. 5) is very similar to the hub assembly B and operates with the CV joint K. However, the internal spline 108 along the bore 32 of the inboard cone 30 extends out to the beveled surface 46 along the back of the recess 44. Moreover, the formed end 22 does not contact the ends of the internal spline 108. Instead, it turns over a circular clip 120 that is fitted around the spindle 12 immediately beyond engaged splines 106 and 108. The clip 120 is formed from a wire of circular cross section and presents a curved surface toward the end portion 78 of the preform 76 prior to deforming the end portion 78 into the formed end 22. In this regard, the clip 120, while circular, is not continuous so it can expand. Initially, the clip 120 has an inside diameter slightly less than the diameter of the end portion 78 on the preform 76. The clip 120 is expanded slightly within its elastic limits and advanced over the end portion 78 until it lies along the end of the internal spline 108 on the cone 30. Once released the clip 120 contracts and snugly grips the end portion 78. Thereupon, the forming tool 80 is forced against the end portion 78. As the end portion 78 deforms outwardly and into the recess 44 of the cone 30, it wraps over the clip 120.

While the circular clip 120 should present a contoured surface toward the formed end 22, it need not be totally circular in cross section. Moreover, circumferentially it may be continuous, although of a size to fit over the end portion 78 of the preform 76 prior to the deformation of the preform 78 into the formed end 22.

In any one of the bearing assemblies A, B or C, the raceways 54 of the bearing 6 may be on separate cups or outer races or on a single double cup or outer race, instead of directly on the housing 4. Moreover, the inboard cone 28 may be formed integral with the hub 2, in which event its raceway 34 is on the spindle 12. Also, the raceways 34 and 54 may be arcuate in cross section, yet oblique to the axis X, and the rolling elements may be balls, all as in angular contact ball bearings.

While it the present invention has been shown and described with reference to a bearing with two rows of rolling elements, the concepts of the present invention apply equally to a single row bearing or a bearing with more than two rows of rolling elements.

What is claimed is:

1. A hub assembly for accommodating rotation about an axis, said hub assembly comprising: a hub located around the axis and having a spindle provided at one end with a formation that is directed outwardly away from the axis; a housing located around the spindle of the hub; at least one outer raceway carried by the housing; at least one raceway carried by the spindle and presented outwardly toward the at least one outer raceway; rolling elements in a row located between the inner and outer raceways; the inner raceway of the bearing being on an inner race that is initially separate from the spindle and has a back face that is presented away from the rolling elements at an angle with respect to the axis, the inner race also having a recess that opens axially out of its back face and receives the formation on the end of the spindle, the back of the recess being along a beveled surface that is oblique to the axis and the formed end being against the beveled surface.

2. A hub assembly according to claim 1 wherein the formation on the spindle comprises a formed end that is integral with the spindle.

3. A hub assembly according to claim 2 wherein the back face of the inner race lies in a plane that is perpendicular to the axis.

4. A hub assembly according to claim 3 wherein the formed end lies entirely within the recess.

5. A hub according to claim 3 wherein the formed end has a beveled inside face that abuts the beveled surface at the back of the recess.

6. A hub according to claim 3 wherein the formed end has an end face that is planar and lies in the plane of the back face on the inner race.

7. A hub according to claim 1 wherein the at least one outer raceway comprises a first and second outer raceway; the at least one inner raceway comprises a first and second inner raceway; and a second row of rolling elements located between the second inner and outer raceway.

8. A hub assembly according to claim 7 wherein the formation on the spindle comprises a formed end that is integral with the spindle and wherein the first and second inner raceways are inclined in opposite directions with respect to the axis; wherein the first and second outer raceways are inclined in opposite directions with respect to the axis, and wherein the direction of the inclination of the first raceways correspond and the direction of the inclination of the second raceways correspond; whereby the rolling elements of the first row transfer thrust loads in one axial direction and the rolling elements of the second row transfer thrust loads in the opposite axial direction.

9. The hub assembly of claim 7 in combination with a CV joint that comprises a shell having a front face that is presented toward the back face of the inner race and a stub shaft which projects beyond the front face and into the spindle of the hub and wherein the formation on the spindle comprises a formed end that is integral with the spindle.

10. The combination according to claim 9 wherein the spindle is hollow has an internal spline and the stub shaft of the CV joint has an external spline that engages the internal spline of the spindle.

11. The combination according to claim 9 wherein the spindle has an external spline and the inner race has an internal spline that engages the external spline of the spindle, wherein the inner race also has an external spline; wherein the CV joint on its shell has an external spline that aligns with the external spline on the inner race; and further comprising a connect-disconnect ring having an internal spline that engages the external spline on the shell of the CV joint and is capable of sliding onto the external spline on the inner race such as to span the two external splines, whereby torque will transfer from the CV joint to the hub.

12. The combination according to claim 11 wherein the hub assembly further comprises an annular element around the spindle where the formed end is directed outwardly.

13. The combination according to 12 wherein the annular element is against the ends of at least one of the splines that engage the inner race with the spindle and against the formed end.

14. The combination according to claim 2 wherein the spindle has an external spline; and wherein the inner race has an internal spline that is engaged with the external spline on the spindle and the inner race also has an external spline that is presented outwardly and is located around the formed end.

15. A hub assembly for accommodating rotation about an axis, said hub assembly comprising: a hub located around the axis and having a spindle provided with a bearing seat and a formed end directed outwardly from the bearing seat as an integral part of the spindle, first and second raceways carried by the spindle and presented outwardly away from, yet oblique to, the axis, the raceways being inclined in opposite directions, at least the second inner raceway being on an inner race that surrounds the bearing seat and has at one of its ends a recess that opens axially out of that end and receives the formed end of the spindle, the back of the recess being defined by a beveled surface along which the formed end abuts the inner race, with the beveled surface being oblique to the axis, a housing located around the axis; a first outer raceway carried by the housing inclined in the same direction as the first inner raceway; a second outer raceway carried by the housing and presented toward and inclined in the same direction as the second inner raceway; first rolling elements arranged in a row between the first inner and outer raceways' and second rolling elements arranged in a row between the second inner and outer raceways.

16. A hub assembly according to claim 15 wherein the formed end is located entirely within the recess in the inner race.

17. A hub assembly according to claim 15 wherein the beveled surface lies within a conical envelope.

18. A hub assembly according to claim 15 wherein the inner race has a back face that lies in a plane perpendicular to the axis and the formed end has an end face that lies substantially within the plane of the back face.

19. A hub assembly according to claim 15 wherein the inner race has an extension that is located axially beyond the second inner raceway and an external spline on the extension; wherein the spindle has an external spline; and wherein the inner race has an internal spline which is engaged with the external spline on the spindle.

20. A hub assembly according to claim 19 wherein the inner race has a back face at the end of the extension, and the formed end does not project axially beyond the back face.

21. A hub assembly according to claim 19 and further comprising an annular element located around the spindle where the formed end is directed outwardly, with the annular element presenting a contoured surface toward the formed end and being against the end of at least one of the splines that engage the inner race with the spindle.

22. The process for producing the bearing assembly of claim 15, said process comprising providing the hub initially with an extended end portion in lieu of the formed end, with the diameter of the end portion being no greater then the diameter of the bearing seat; installing the rollers of the first and second rows, the housing and the inner race over the spindle; and deforming the end portion of the spindle outwardly into the recess of the inner race, with the transformation from the end portion to the formed end effecting a plastic deformation to the spindle and a totally different cross-sectional configuration.
